(19) United States
(12) Patent Application Publication
(10) Pub. No.: US 2020/0271467 A1
(43) Pub. Date: Aug. 27, 2020

(54) OPERATION SUPPORT DEVICE, VEHICLE, OPERATION MANAGEMENT DEVICE, TERMINAL DEVICE, AND OPERATION SUPPORT METHOD

(71) Applicant: TOYOTA JIDOSHA KABUSHIKI KAISHA, Toyota-shi (JP)

(72) Inventors: Taiki YOSHIDA, Tokyo (JP); Saiko TOYODA, Nagoya-shi (JP)

(73) Assignee: TOYOTA JIDOSHA KABUSHIKI KAISHA, Toyota-shi (JP)

(21) Appl. No.: 16/736,885

(22) Filed: Jan. 8, 2020

(30) Foreign Application Priority Data
Feb. 26, 2019 (JP) 2019-033372

(51) Int. Cl. G01C 21/34; G01C 21/36; G08G 1/00; G06Q 10/02; H04W 4/40

(52) U.S. Cl. CPC G01C 21/3438; G01C 21/3605; H04W 4/40; G06Q 10/02; G08G 1/202

(57) ABSTRACT

An operation support device is a device for supporting an operation of a vehicle for which an operation plan is determined in accordance with a boarding position requested by a reservation made by a user. The operation support device includes a controlling portion configured to acquire position information of the vehicle when identification information of the user is transmitted from a terminal device of the user in response to identification information of the vehicle that is wirelessly transmitted from the vehicle during operation, the controlling portion being configured to compare the acquired position information with information on the boarding position associated with the identification information of the user at the time of making the reservation.

### INCORPORATION BY REFERENCE

The disclosure of Japanese Patent Application No. 2019-033372 filed on Feb. 26, 2019 including the specification, drawings and abstract is incorporated herein by reference in its entirety.

### BACKGROUND

### 1. Technical Field

The present disclosure relates to an operation support device, a vehicle, an operation management device, a terminal device, and an operation support method.

### 2. Description of Related Art

Japanese Unexamined Patent Application Publication No. 2010-216869 (JP 2010-216869 A) describes a technique in which, when it is detected that a person boards a vehicle based on a signal from a microphone or a camera, current position information of the vehicle is acquired as boarding position information, and a database is referred to and searched for personal identification information corresponding to the acquired boarding position information.

Japanese Unexamined Patent Application Publication No. 2010-176221 (JP 2010-176221 A) describes a technique in which, when it is determined that a vehicle stops at a station and it is determined that a user is in the station, boarding guidance information including a direction to which the user should move to reach an entrance and a distance by which the user should move to reach the entrance is transmitted to a user terminal.

### SUMMARY

There is an on-demand traffic system such as an on-demand bus for which an operation plan such as a travel route and an operation schedule is determined in accordance with boarding and getting-off positions and boarding and getting-off times requested by a reservation of a user. In such an on-demand traffic system, when a person boards a vehicle, it is necessary to check whether the person is the user who has made the reservation.

In the technique described in JP 2010-216869 A, when the person boards the vehicle, the personal identification information corresponding to the boarding position information is obtained, but it cannot be checked whether the personal identification information is personal identification information of the person who boards the vehicle.

In the technique described in JP 2010-176221 A, a user terminal ID of the person is obtained before the person boards the vehicle. However, the user terminal ID is used only to transmit, to the user terminal, bus approach information and bus arrival information in terms of a line requested by the person, and the user terminal ID is not used at all when the person boards the vehicle. Here, “ID” is an abbreviation of identifier.

An object of the present disclosure is to check whether or not a person is a user who has made a reservation, when the person boards a vehicle.

An operation support device according to one aspect of the present disclosure is an operation support device for supporting an operation of a vehicle for which an operation plan is determined in accordance with a boarding position requested by a reservation made by a user. The operation support device includes a controlling portion configured to acquire position information of the vehicle when identification information of the user is transmitted from a terminal device of the user in response to identification information of the vehicle that is wireles sly transmitted from the vehicle during operation, the controlling portion being configured to compare the acquired position information with information on the boarding position associated with the identification information of the user at the time of making the reservation.

An operation management device according to one aspect of the present disclosure includes a communication portion and a controlling portion. The communication portion is configured to transmit and receive information. The controlling portion is configured to receive, through the communication portion, identification information of a user that is transmitted from a vehicle for which an operation plan is determined in accordance with a boarding position requested by a reservation made by the user, the identification information of the user being transmitted from the vehicle during operation. The controlling portion is configured to transmit, through the communication portion, information on the boarding position associated with the identification information of the user at the time of making the reservation, in response to the identification information of the user.

A terminal device according to one aspect of the present disclosure includes a communication portion and a controlling portion. The communication portion is configured to wirelessly transmit and receive information. The controlling portion is configured to receive, through the communication portion, identification information of a vehicle for which an operation plan is determined in accordance with a boarding position requested by a reservation made by a user, the identification information of the vehicle being wirelessly transmitted from the vehicle during operation. The controlling portion is configured to transmit, through the communication portion, identification information of the user in response to the identification information of the vehicle.

An operation support method according to one aspect of the present disclosure includes: wirelessly transmitting identification information of a vehicle for which an operation plan is determined in accordance with a boarding position requested by a reservation made by a user, the identification information of the vehicle being transmitted by the vehicle during operation; receiving, by a terminal device of the user, the identification information of the vehicle; transmitting, by the terminal device of the user, identification information of the user in response to the identification information of the vehicle; acquiring, by an operation support device, position information of the vehicle; and comparing, by the operation support device, the acquired position information with information on the boarding position associated with the identification information of the user at the time of making the reservation.

With one aspect of the present disclosure, when a person boards a vehicle, it is possible to check whether or not the person is a user who has made a reservation.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view illustrating a configuration of an on-demand traffic system according to one embodiment of the present disclosure;

FIG. 2 is a block diagram illustrating the configuration of the on-demand traffic system according to one embodiment of the present disclosure;

FIG. 3 is a flowchart illustrating an operation of the on-demand traffic system according to one embodiment of the present disclosure;

FIG. 4 is a table illustrating an example of a reservation request according to one embodiment of the present disclosure.

FIG. 5 is a table illustrating an example of a database according to one embodiment of the present disclosure;

FIG. 6 is a table illustrating an example of a reservation response according to one embodiment of the present disclosure;

FIG. 7 is a flowchart illustrating an operation of the on-demand traffic system according to one embodiment of the present disclosure;

FIG. 8 is a flowchart illustrating an operation of the on-demand traffic system according to one embodiment of the present disclosure;

FIG. 9 is a view illustrating an example of acceptance request information according to one embodiment of the present disclosure;

FIG. 10 is a view illustrating an example of boarding guidance information according to one embodiment of the present disclosure; and

FIG. 11 is a view illustrating an example of getting-off guidance information according to one embodiment of the present disclosure.

### DETAILED DESCRIPTION OF EMBODIMENTS

One embodiment of the present disclosure will be described below with reference to the drawings.

The same or equivalent portions in the drawings have the same sign. In the following description of the present embodiment, in terms of the same or equivalent portions, descriptions are omitted or simplified appropriately.

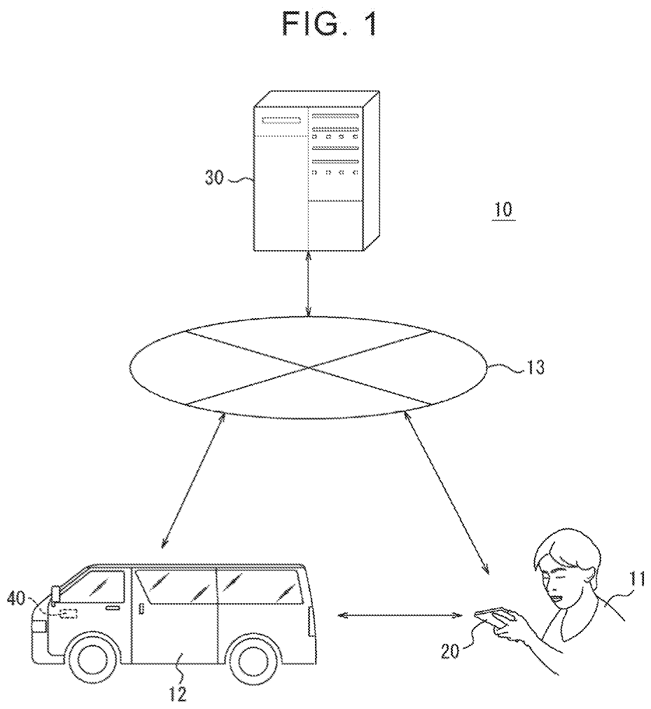

With reference to FIG. 1, the outline of the present embodiment will be described below.

In an on-demand traffic system 10 according to the present embodiment, an operation plan of a vehicle 12 is determined in accordance with a boarding position requested by a reservation made by a user 11. The vehicle 12 wirelessly transmits identification information of the vehicle 12 during operation. A terminal device 20 of the user 11 receives the identification information of the vehicle 12. The terminal device 20 transmits identification information of the user 11 in response to the identification information of the vehicle 12. An operation management device 30 transmits, to an operation support device 40 at a given point of time, information on the boarding position associated with the identification information of the user 11 at the time of making the reservation. The operation support device 40 acquires position information of the vehicle 12. The operation support device 40 compares the position information thus acquired with the information on the boarding position associated with the identification information of the user 11 at the time of making the reservation.

In the present embodiment, when a person boards a vehicle, identification information of the person is acquired, and a boarding position requested by the person at the time of making a reservation is specified by use of the identification information. Accordingly, when the person boards the vehicle, the position of the vehicle 12 is compared with the boarding position requested by the person, so that it is possible to check whether or not the person is the user 11 who has made the reservation.

In the present embodiment, the user 11 accesses the operation management device 30 from the terminal device 20 and makes a reservation for the vehicle 12 without an operator. However, the user 11 may make a reservation for the vehicle 12 by communicating with an operator who can access the operation management device 30 by phone or by email.

The vehicle 12 is an on-demand bus in the present embodiment but may be other types of on-demand vehicles such as a shared taxi. As the on-demand bus, an automobile of a given type such as a gasoline-powered car, a diesel car, an HV, a PHV, an EV, or an FCV can be used. Here, “HV” is an abbreviation of Hybrid Vehicle. Further, “PHV” is an abbreviation of Plug-in Hybrid Vehicle. Further, “EV” is an abbreviation of Electric Vehicle. Further, “FCV” is an abbreviation of Fuel Cell Vehicle. The vehicle 12 is driven by a driver in the present embodiment, but its operation may be automated at a given level. The level of the automation is any level from level 1 to level 5 based on the classification of the SAE, for example. Here, “SAE” is an abbreviation of Society of Automotive Engineers. The vehicle 12 may be also a vehicle for exclusive use of MaaS. Here, “MaaS” is an abbreviation of Mobility as a Service.

The relationship between the user 11 and the vehicle 12 is not limited to a one-to-one relationship and may be a one-to-many relationship, a many-to-one relationship, or a many-to-many relationship. The user 11 may be an unspecified number of people. The vehicle 12 may be also used as a ride-sharing vehicle.

The terminal device 20 and the operation support device 40 are communicable with the operation management device 30 via a network 13 such as a movable body communication network or the Internet. Further, the terminal device 20 and the operation support device 40 are wireles sly communicable with each other without the network 13.

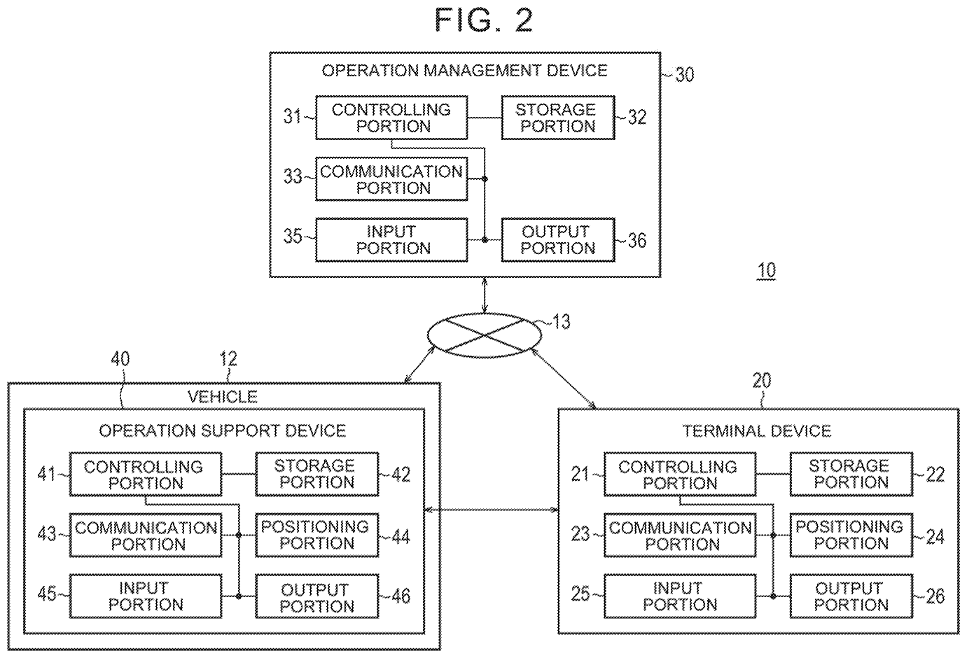

With reference to FIG. 2, the following describes the configuration of the on-demand traffic system 10 according to the present embodiment.

The on-demand traffic system 10 includes the terminal device 20, the operation management device 30, and the operation support device 40.

The terminal device 20 is a device used by the user 11 who makes a reservation for the vehicle 12. The terminal device 20 is constituted as a mobile device such as a mobile phone device, a smartphone, or a tablet that is carried by the user 11.

The terminal device 20 includes constituents such as a controlling portion 21, a storage portion 22, a communication portion 23, a positioning portion 24, an input portion 25, and an output portion 26.

The controlling portion 21 is constituted by one or more processors. As the processor, a general purpose processor such as a CPU or a dedicated processor devoted to a specific process can be used. Here, “CPU” is an abbreviation of Central Processing Unit. One or more dedicated communication circuits may be included in the controlling portion 21, or one or more processors may be replaced with one or more dedicated communication circuits in the controlling portion 21. As the dedicated communication circuit, an FPGA or an ASIC can be used, for example. Here, “FPGA” is an abbreviation of Field-Programmable Gate Array. Further, “ASIC” is an abbreviation of Application Specific Integrated Circuit. The controlling portion 21 executes information processing related to the operation of the terminal device 20 while the controlling portion 21 controls each part of the terminal device 20.

The storage portion 22 is constituted by one or more memories. As the memory, a semiconductor memory, a magnetic memory, or an optical memory can be used, for example. As the semiconductor memory, a RAM or a ROM can be used, for example. Here, “RAM” is an abbreviation of Random Access Memory. Further, “ROM” is an abbreviation of Read Only Memory. As the RAM, an SRAM or a DRAM can be used, for example. Here, “SRAM” is an abbreviation of Static Random Access Memory. Further, “DRAM” is an abbreviation of Dynamic Random Access Memory. As the ROM, an EEPROM can be used, for example. Here, “EEPROM” is an abbreviation of Electrically Erasable Programmable Read Only Memory. The memory functions as a main storage device, an auxiliary storage device, or a cache memory, for example. Information used for the operation of the terminal device 20 and information obtained by the operation of the terminal device 20 are stored in the storage portion 22.

The communication portion 23 is constituted by one or more data communication modules. As the data communication module, a data communication module corresponding to BLE, RFID, a wireless LAN standard, LTE, 4G, or 5G can be used, for example. Here, “BLE” is an abbreviation of Bluetooth (registered trademark) Low Energy. Further, “RFID” is an abbreviation of Radio Frequency Identification. Further, “LAN” is an abbreviation of Local Area Network. Further, “LTE” is an abbreviation of Long Term Evolution. Further, “4G” is an abbreviation of 4th Generation. Further, “5G” is an abbreviation of 5th Generation. The communication portion 23 wirelessly receives information used for the operation of the terminal device 20 and wirelessly transmits information obtained by the operation of the terminal device 20.

The positioning portion 24 is constituted by one or more positioning modules. As the positioning module, a positioning module corresponding to a GNSS can be used, for example. Here, “GNSS” is an abbreviation of Global Navigation Satellite System. The GNSS includes at least one of a GPS, a QZSS, a GLONASS, and Galileo, for example. Here, “GPS” is an abbreviation of Global Positioning System. Further, “QZSS” is an abbreviation of Quasi-Zenith Satellite System. A satellite of the QZSS is referred to as a quasi-zenith satellite. Further, “GLONASS” is an abbreviation of Global Navigation Satellite System. The positioning portion 24 acquires position information of the terminal device 20.

The input portion 25 is constituted by one or more input interfaces. As the input interface, a physical key, an electrostatic capacitive key, a pointing device, a touchscreen provided integrally with a display, or a microphone can be used, for example. The input portion 25 receives an operation by the user 11 such as input of information to be used for the operation of the terminal device 20.

The output portion 26 is constituted by one or more output interfaces. As the output interface, a display or a speaker can be used, for example. As the display, an LCD or an organic EL display can be used, for example. Here, “LCD” is an abbreviation of Liquid Crystal Display. Further, “EL” is an abbreviation of Electro Luminescence. The output portion 26 outputs information to be obtained by the operation of the terminal device 20 to the user 11.

The functions of the terminal device 20 are implemented by executing a terminal program of the present embodiment by a processor included in the controlling portion 21. That is, the functions of the terminal device 20 are implemented by software. The terminal program is a program for causing a computer to implement a function corresponding to a process of a step included in the operation of the terminal device 20 by causing the computer to execute the process of the step. That is, the terminal program is a program to functionalize the computer as the terminal device 20.

The program can be stored in a computer-readable recording medium. As the computer-readable recording medium, a magnetic recorder, an optical disc, a magneto-optical recording medium, or a semiconductor memory can be used, for example.

The program is distributed by selling, transferring, or lending a portable recording medium such as a DVD or a CD-ROM in which the program is stored, for example. Here, “DVD” is an abbreviation of Digital Versatile Disc. Further, “CD-ROM” is an abbreviation of Compact Disc Read Only Memory. The program may be distributed by storing the program in a storage of a server and transferring the program to other computers from the server via the network 13. The program may be provided as a program product.

The computer temporarily stores, in the memory, the program stored in the portable recording medium or the program transferred from the server. Then, the computer reads, by the processor, the program stored in the memory and executes, by the processor, a process in accordance with the program thus read. The computer may directly read the program from the portable recording medium and execute the process in accordance with the program. The computer may sequentially execute the process in accordance with the program every time the program is transferred to the computer from the server. The process may be executed by a so-called ASP service that implements the function only by an execution instruction and result acquisition without transferring the program from the server to the computer. Here, “ASP” is an abbreviation of Application Service Provider. The program includes a matter that is information used for processing by an electronic computer and is equivalent to the program. For example, data that is not a direct command to the computer but has a property defining the processing of the computer corresponds to “the matter equivalent to the program.”

Some of or all of the functions of the terminal device 20 may be implemented by a dedicated communication circuit included in the controlling portion 21. That is, some of or all of the functions of the terminal device 20 may be implemented by hardware.

The operation management device 30 is a device configured to manage the operation of the vehicle 12. The operation management device 30 is provided in a given place such as a data center. The operation management device 30 is constituted as a server belonging to a cloud computing system or other computing systems.

The operation management device 30 includes constituents such as a controlling portion 31, a storage portion 32, a communication portion 33, an input portion 35, and an output portion 36.

The controlling portion 31 is constituted by one or more processors. As the processor, a general purpose processor such as a CPU or a dedicated processor devoted to a specific process can be used. One or more dedicated communication circuits may be included in the controlling portion 31, or one or more processors may be replaced with one or more dedicated communication circuits in the controlling portion 31. As the dedicated communication circuit, an FPGA or an ASIC can be used, for example. The controlling portion 31 executes information processing related to the operation of the operation management device 30 while the controlling portion 31 controls each part of the operation management device 30.

The storage portion 32 is constituted by one or more memories. As the memory, a semiconductor memory, a magnetic memory, or an optical memory can be used, for example. As the semiconductor memory, a RAM or a ROM can be used, for example. As the RAM, an SRAM or a DRAM can be used, for example. As the ROM, an EEPROM can be used, for example. The memory functions as a main storage device, an auxiliary storage device, or a cache memory, for example. Information used for the operation of the operation management device 30 and information obtained by the operation of the operation management device 30 are stored in the storage portion 32.

The communication portion 33 is constituted by one or more data communication modules. As the data communication module, a data communication module corresponding to a LAN standard can be used, for example. The communication portion 33 receives information used for the operation of the operation management device 30 via the network 13 and transmits information obtained by the operation of the operation management device 30 via the network 13.

The input portion 35 is constituted by one or more input interfaces. As the input interface, a physical key, an electrostatic capacitive key, a pointing device, a touchscreen provided integrally with a display, or a microphone can be used, for example. The input portion 35 receives an operation such as input, by an operator, of information used for the operation of the operation management device 30.

The output portion 36 is constituted by one or more output interfaces. As the output interface, a display or a speaker can be used, for example. As the display, an LCD or an organic EL display can be used, for example. The output portion 36 outputs information to be provided by the operation of the operation management device 30 to the operator.

The functions of the operation management device 30 are implemented by executing an operation management program of the present embodiment by a processor included in the controlling portion 31. That is, the functions of the operation management device 30 are implemented by software. The operation management program is a program for causing a computer to implement a function corresponding to a process of a step included in the operation of the operation management device 30 by causing the computer to execute the process of the step. That is, the operation management program is a program to functionalize the computer as the operation management device 30.

Some of or all of the functions of the operation management device 30 may be implemented by a dedicated communication circuit included in the controlling portion 31. That is, some of or all of the functions of the operation management device 30 may be implemented by hardware.

The operation support device 40 is a device configured to support the operation of the vehicle 12. The operation support device 40 is provided in the vehicle 12. The operation support device 40 may be constituted as an in-vehicle device such as a fare display machine, a fare collection machine, or a navigation device, or the operation support device 40 may be constituted as an electronic device used by being connected to an in-vehicle device such as a mobile phone device, a smartphone, or a tablet.

The operation support device 40 includes constituents such as a controlling portion 41, a storage portion 42, a communication portion 43, a positioning portion 44, an input portion 45, and an output portion 46.

The controlling portion 41 is constituted by one or more processors. As the processor, a general purpose processor such as a CPU or a dedicated processor devoted to a specific process can be used. One or more dedicated communication circuits may be included in the controlling portion 41, or one or more processors may be replaced with one or more dedicated communication circuits in the controlling portion 41. As the dedicated communication circuit, an FPGA or an ASIC can be used, for example. One or more ECUs may be included in the controlling portion 41. Here, “ECU” is an abbreviation of Electronic Control Unit. The controlling portion 41 executes information processing related to the operation of the operation support device 40 while the controlling portion 41 controls each part of the vehicle 12 including the operation support device 40.

The storage portion 42 is constituted by one or more memories. As the memory, a semiconductor memory, a magnetic memory, or an optical memory can be used, for example. As the semiconductor memory, a RAM or a ROM can be used, for example. As the RAM, an SRAM or a DRAM can be used, for example. As the ROM, an EEPROM can be used, for example. The memory functions as a main storage device, an auxiliary storage device, or a cache memory, for example. Information used for the operation of the operation support device 40 and information obtained by the operation of the operation support device 40 are stored in the storage portion 42.

The communication portion 43 is constituted by one or more data communication modules. As the data communication module, a data communication module corresponding to BLE, RFID, a wireless LAN standard, LTE, 4G, or 5G can be used, for example. The communication portion 43 wirelessly receives information used for the operation of the operation support device 40 and wirelessly transmits information obtained by the operation of the operation support device 40.

The positioning portion 44 is constituted by one or more positioning modules. As the positioning module, a positioning module corresponding to a GNSS can be used, for example. The GNSS includes at least one of a GPS, a QZSS, a GLONASS, and Galileo, for example. The positioning portion 44 acquires position information of the vehicle 12.

The input portion 45 is constituted by one or more input interfaces. As the input interface, a physical key, an electrostatic capacitive key, a pointing device, a touchscreen provided integrally with an in-vehicle display, or an in-vehicle microphone can be used, for example. The input portion 45 receives an operation such as input, by the driver of the vehicle 12, of information used for the operation of the operation support device 40.

The output portion 46 is constituted by one or more output interfaces. As the output interface, an in-vehicle display or an in-vehicle speaker can be used, for example. As the in-vehicle display, an HUD, an LCD, or an organic EL display can be used, for example. Here, “HUD” is an abbreviation of Head-Up Display. The output portion 46 outputs information to be obtained by the operation of the operation support device 40 to the driver of the vehicle 12.

The functions of the operation support device 40 are implemented by executing an operation support program of the present embodiment by a processor included in the controlling portion 41. That is, the functions of the operation support device 40 are implemented by software. The operation support program is a program for causing a computer to implement a function corresponding to a process of a step included in the operation of the operation support device 40 by causing the computer to execute the process of the step. That is, the operation support program is a program to functionalize the computer as the operation support device 40.

Some of or all of the functions of the operation support device 40 may be implemented by a dedicated communication circuit included in the controlling portion 41. That is, some of or all of the functions of the operation support device 40 may be implemented by hardware.

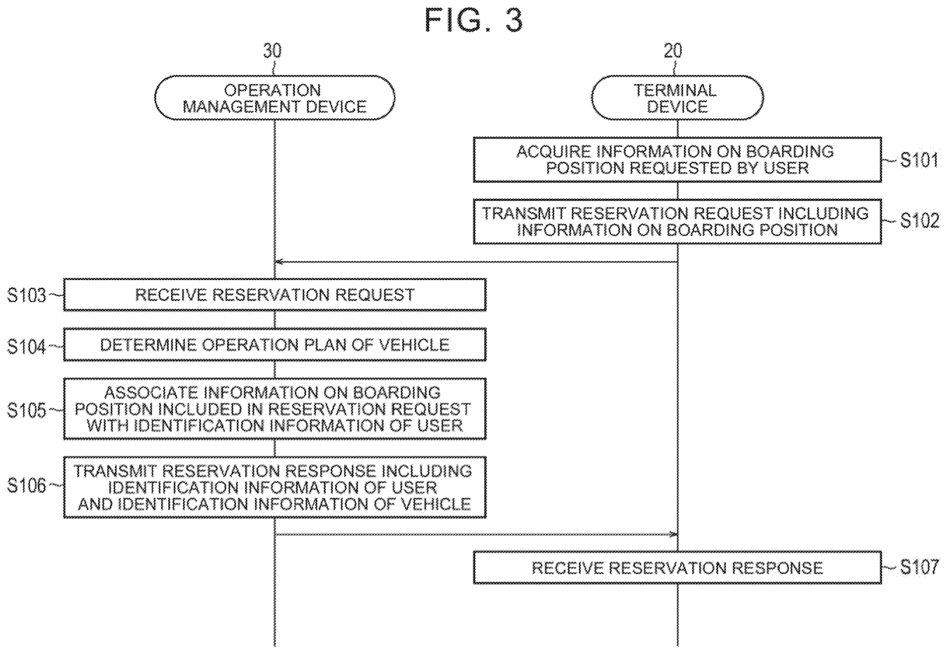

With reference to FIGS. 3 to 11, the following describes the operation of the on-demand traffic system 10 according to the present embodiment.

FIG. 3 illustrates the operation of the on-demand traffic system 10 at the time when the user 11 makes a reservation for the vehicle 12. This operation corresponds to a reservation support method according to the present embodiment.

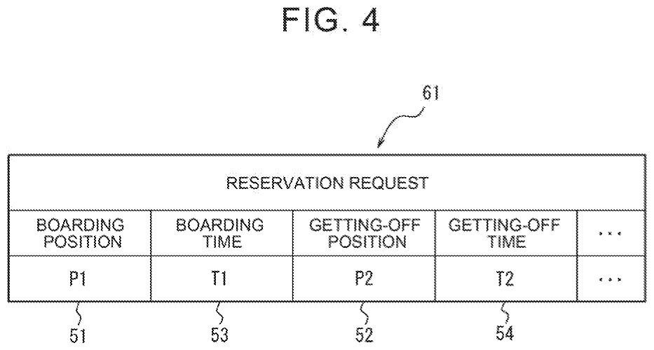

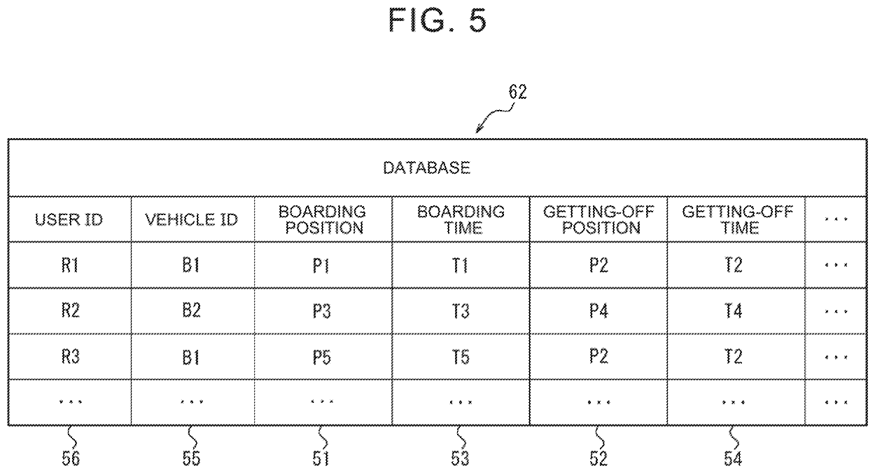

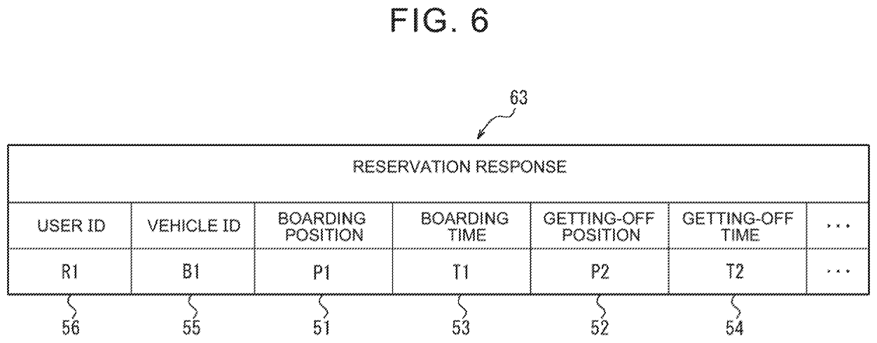

FIG. 4 illustrates an example of a reservation request 61 transmitted and received in the operation of FIG. 3. FIG. 5 illustrates an example of a database 62 to be accessed in the operation of FIG. 3. FIG. 6 illustrates an example of a reservation response 63 transmitted and received in the operation of FIG. 3.

Processes of step S101 and step S102 are executed by the terminal device 20 of the user 11.

In step S101, the controlling portion 21 acquires information on a boarding position requested by the user 11 via the input portion 25. In the present embodiment, the controlling portion 21 further acquires information on a getting-off position requested by the user 11 via the input portion 25. The controlling portion 21 also acquires pieces of information on a boarding time and a getting-off time requested by the user 11 via the input portion 25.

More specifically, the controlling portion 21 receives operations by the user 11 to input boarding position information 51, getting-off position information 52, boarding time information 53, and getting-off time information 54 via the input portion 25. The boarding position information 51 is information on a boarding position P1 requested by the user 11. The getting-off position information 52 is information on a getting-off position P2 requested by the user 11. The boarding position P1 and the getting-off position P2 are expressed in a given form such as a place name, an address, or a point or a region on a map. The boarding time information 53 is information on a boarding time T1 requested by the user 11. The getting-off time information 54 is information on a getting-off time T2 requested by the user 11. The boarding time T1 and the getting-off time T2 are expressed in a given form such as date and time or a date and a time slot. The controlling portion 21 stores, in the storage portion 22, the boarding position information 51, the getting-off position information 52, the boarding time information 53, and the getting-off time information 54 thus input.

In step S102, the controlling portion 21 transmits the reservation request 61 including the information on the boarding position acquired in step S101 to the operation management device 30 through the communication portion 23. In the present embodiment, the controlling portion 21 further includes, in the reservation request 61, the information on the getting-off position that is acquired in step S101. The controlling portion 21 also includes, in the reservation request 61, the pieces of information on the boarding time and the getting-off time that are acquired in step S101.

More specifically, as illustrated in FIG. 4, the controlling portion 21 generates, as the reservation request 61, a message including the boarding position information 51, the getting-off position information 52, the boarding time information 53, and the getting-off time information 54 stored in the storage portion 22. As the type of the message, a given type such as HTML or XML can be used. Here, “HTML” is an abbreviation of Hypertext Markup Language. Further, “XML” is an abbreviation of Extensible Markup Language. The controlling portion 21 transmits the reservation request 61 thus generated to the operation management device 30 through the communication portion 23.

Processes from step S103 to step S106 are executed by the operation management device 30.

In step S103, the controlling portion 31 receives the reservation request 61 transmitted in step S102 from the terminal device 20 of the user 11 through the communication portion 33.

More specifically, the controlling portion 31 receives, through the communication portion 33, the reservation request 61 including the boarding position information 51, the getting-off position information 52, the boarding time information 53, and the getting-off time information 54 from the terminal device 20 of the user 11 via the network 13. The controlling portion 31 stores, in the storage portion 32, the boarding position information 51, the getting-off position information 52, the boarding time information 53, and the getting-off time information 54 included in the reservation request 61 thus received.

In step S104, the controlling portion 31 determines an operation plan of the vehicle 12 in accordance with the information on the boarding position that is included in the reservation request 61 received in step S103. In the present embodiment, the controlling portion 31 determines the operation plan of the vehicle 12 in accordance with the information on the boarding position and the pieces of information on the getting-off position, the boarding time, and the getting-off time that are included in the reservation request 61 received in step S103.

More specifically, the controlling portion 31 arranges the vehicle 12 in accordance with the request of the user 11 that is designated by the boarding position information 51, the getting-off position information 52, the boarding time information 53, and the getting-off time information 54 that are stored in the storage portion 32 and determines the operation plan such as a travel route and an operation schedule for the vehicle 12 thus arranged. The controlling portion 31 stores a vehicle ID 55 of the arranged vehicle 12 in the storage portion 32 as identification information of the vehicle 12. The vehicle ID 55 is a given value or text.

In a case where the controlling portion 31 receives the reservation request 61 as illustrated in the example of FIG. 4, the controlling portion 31 selects, from among a plurality of candidate on-demand buses, a bus B1 that can arrive at the boarding position P1 by the boarding time T1 and reach the getting-off position P2 by the getting-off time T2. The controlling portion 31 determines an operation plan of the bus B1 so that the bus B1 can arrive at the boarding position P1 by the boarding time T1 and reach the getting-off position P2 by the getting-off time T2.

In step S105, the controlling portion 31 associates the information on the boarding position that is included in the reservation request 61 received in step S103 with identification information of the user 11. In the present embodiment, the controlling portion 31 further associates the information on the getting-off position that is included in the reservation request 61 received in step S103 with the identification information of the user 11. The controlling portion 31 also associates the pieces of information on the boarding time and the getting-off time that are included in the reservation request 61 received in step S103 with the identification information of the user 11.

More specifically, the controlling portion 31 issues a new user ID 56 as the identification information of the user 11. As illustrated in FIG. 5, the controlling portion 31 registers the user ID 56 thus issued in the storage portion 32 or the database 62 constructed in an external storage as a main key and registers, in the database 62 in association with the user ID 56, the vehicle ID 55, the boarding position information 51, the getting-off position information 52, the boarding time information 53, and the getting-off time information 54 that are stored in the storage portion 32. The user ID 56 is a given value such as a random number or a given text such as a random text.

The user ID 56 issued herein is not only the identification information of the user 11, but also identification information of a reservation R1 made by the user 11. If there is another reservation R2 made by the same user 11, the controlling portion 31 issues another user ID 56 as identification information of the reservation R2 as illustrated in the example of FIG. 5. In this example, it is not necessary to issue the user ID 56 before the user 11 makes a reservation, and it is also not necessary to authenticate the user 11 at the time of making a reservation, thereby making it possible to simplify the procedure of the process.

In step S106, the controlling portion 31 transmits the reservation response 63 including the identification information of the user 11 and the identification information of the vehicle 12 to the terminal device 20 of the user 11 through the communication portion 33.

More specifically, the controlling portion 31 generates, as the reservation response 63, a message including a pair of the user ID 56 and the vehicle ID 55 registered in the database 62 as illustrated in FIG. 6. As the type of the message, a given type such as HTML or XML can be used. In the example of FIG. 6, the boarding position information 51, the getting-off position information 52, the boarding time information 53, and the getting-off time information 54 are also included in the reservation response 63, although not necessary. The controlling portion 31 transmits the reservation response 63 thus generated to the terminal device 20 of the user 11 via the network 13 through the communication portion 33.

A process of step S107 is executed by the terminal device 20 of the user 11.

In step S107, the controlling portion 21 receives the reservation response 63 transmitted in step S106 from the operation management device 30 through the communication portion 23.

More specifically, the controlling portion 21 receives the reservation response 63 including the user ID 56 and the vehicle ID 55 from the operation management device 30 through the communication portion 23. The controlling portion 21 stores, in the storage portion 22, the user ID 56 and the vehicle ID 55 included in the reservation response 63 thus received. In a case where the controlling portion 21 receives the reservation response 63 as illustrated in the example of FIG. 6, the controlling portion 21 also stores, in the storage portion 22, the boarding position information 51, the getting-off position information 52, the boarding time information 53, and the getting-off time information 54.

As one modification of the present embodiment, the user ID 56 may be issued by the terminal device 20 of the user 11 instead of being issued by the operation management device 30. In that case, in step S102, the controlling portion 21 of the terminal device 20 includes the user ID 56 thus issued in the reservation request 61. In step S105, the controlling portion 31 of the operation management device 30 registers the user ID 56 included in the reservation request 61 in the database 62.

As one modification of the present embodiment, the user ID 56 may be issued by the operation management device 30 before the user makes a reservation. In that case, in step S102, the controlling portion 21 of the terminal device 20 includes the user ID 56 provided in advance in the reservation request 61. In step S105, the controlling portion 31 of the operation management device 30 registers the user ID 56 included in the reservation request 61 in the database 62.

In this modification, the user 11 may be authenticated by the operation management device 30 at the time of making a reservation. In that case, in step S102, the controlling portion 21 of the terminal device 20 includes authentication information such as a personal identification number or a password corresponding to the user ID 56 in the reservation request 61. In step S104, the controlling portion 31 of the operation management device 30 authenticates the user 11 by comparing the user ID 56 and the authentication information included in the reservation request 61 with the user ID 56 and the authentication information registered in the database 62 in advance. Only when the authentication is successful, the controlling portion 31 determines the operation plan of the vehicle 12.

As one modification of the present embodiment, the processes from step S101 to step S103 may be replaced by communication by telephone or e-mail between the user 11 and the operator. In this case, the user 11 notifies the operator of the boarding position information 51, the getting-off position information 52, the boarding time information 53, and the getting-off time information 54 by telephone or e-mail. In step S103, the controlling portion 31 of the operation management device 30 receives operations by the operator to input the boarding position information 51, the getting-off position information 52, the boarding time information 53, and the getting-off time information 54 through the input portion 35. Alternatively, the controlling portion 31 receives, through the communication portion 33, the boarding position information 51, the getting-off position information 52, the boarding time information 53, and the getting-off time information 54 from a terminal device, of the operator, such as a PC. Here, “PC” is an abbreviation of Personal Computer.

In this modification, the processes of step S106 and step S107 may be replaced by communication by telephone or e-mail between the user 11 and the operator. In that case, the operator notifies the user 11 of the user ID 56 and the vehicle ID 55 by telephone or e-mail. In step S107, the controlling portion 21 of the terminal device 20 receives operations by the user 11 to input the user ID 56 and the vehicle ID 55 through the input portion 25.

As one modification of the present embodiment, the operation plan of the vehicle 12 may be determined manually by the operator. In this case, in step S104, the controlling portion 31 of the operation management device 30 outputs, to the operator through the output portion 36, the boarding position information 51, the getting-off position information 52, the boarding time information 53, and the getting-off time information 54.

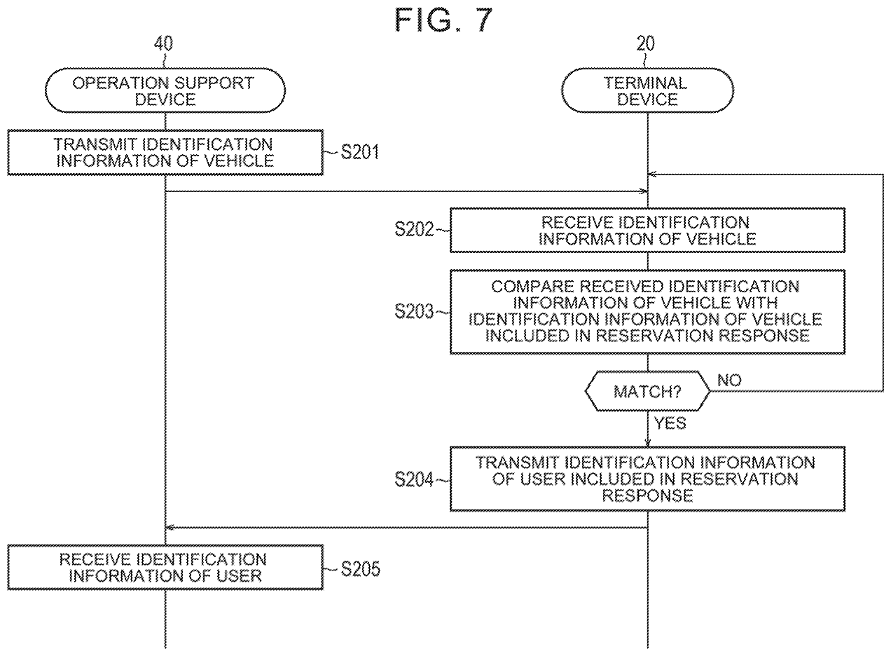

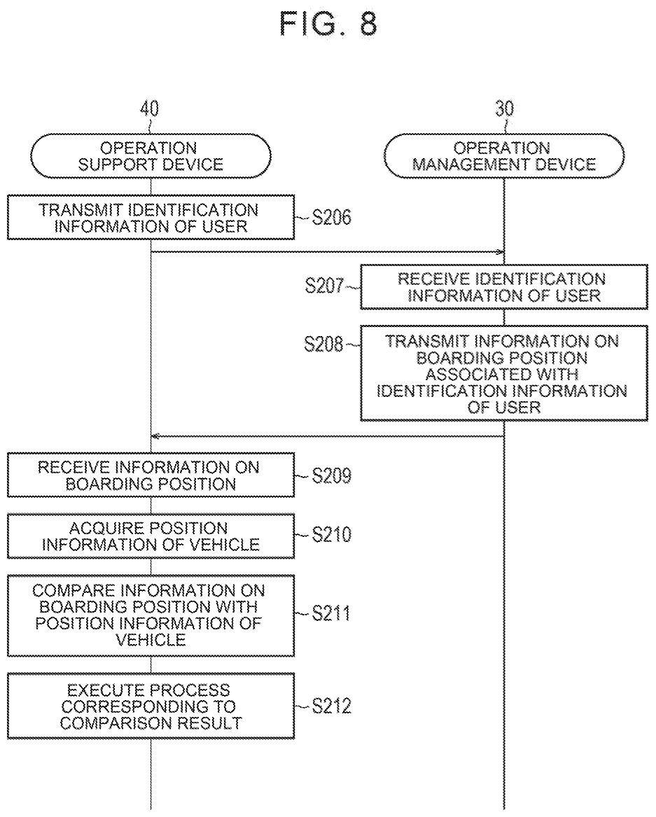

FIGS. 7 and 8 illustrate the operation of the on-demand traffic system 10 at the time when the user 11 boards the vehicle. This operation corresponds to an operation support method according to the present embodiment.

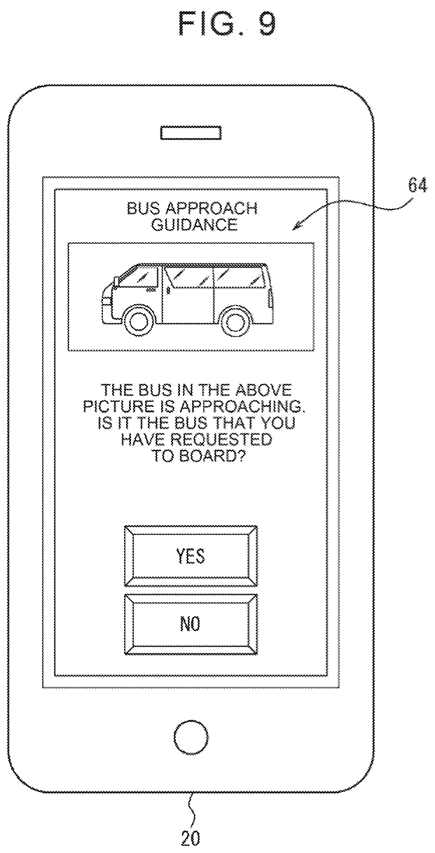

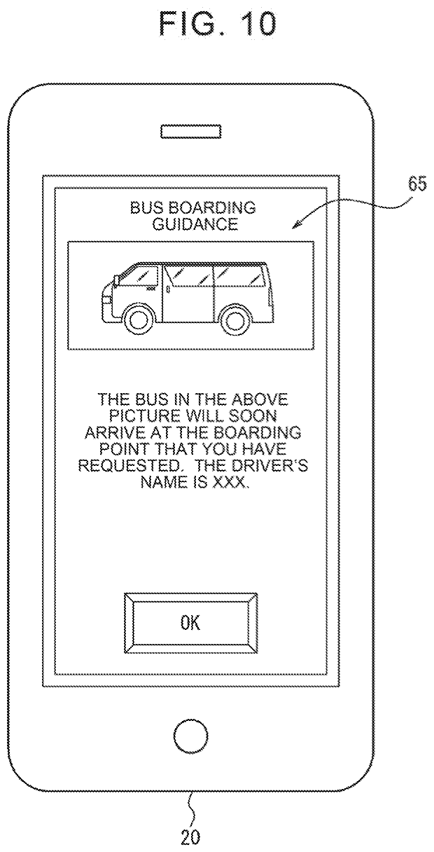

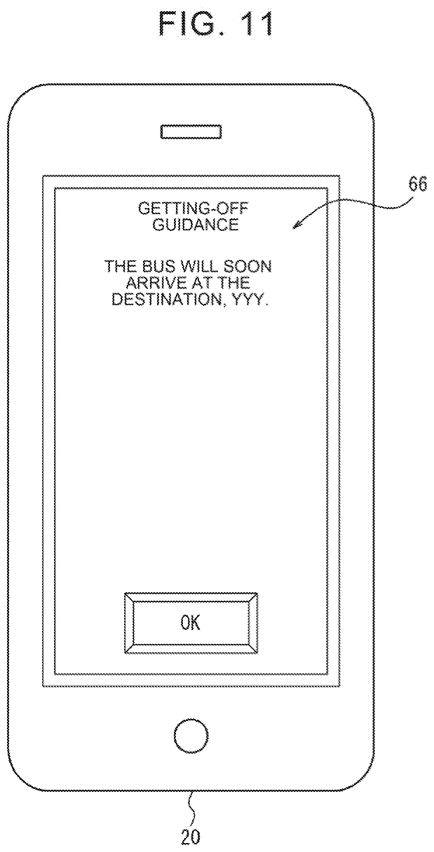

FIG. 9 illustrates an example of acceptance request information 64 output in the operation of FIG. 7. FIG. 10 illustrates an example of boarding guidance information 65 output in the operation of FIG. 8. FIG. 11 illustrates an example of getting-off guidance information 66 output in the operation of FIG. 8.

A process of step S201 is executed by the operation support device 40 of the vehicle 12 during operation.

In step S201, the controlling portion 41 wirelessly transmits identification information of the vehicle 12 from the vehicle 12 during operation through the communication portion 43. In the present embodiment, the controlling portion 41 repeatedly broadcasts the identification information of the vehicle 12 like a beacon through the communication portion 43. The controlling portion 41 may broadcast the identification information of the vehicle 12 regularly or may broadcast the identification information of the vehicle 12 in response to a given trigger. The controlling portion 41 may transmit the identification information of the vehicle 12 regardless of the position of the vehicle 12 or may transmit the identification information of the vehicle 12 only when the position of the vehicle 12 is close to the boarding position requested by the user 11.

More specifically, the controlling portion 41 transmits the vehicle ID 55 stored in the storage portion 42 in advance to outside the vehicle 12 through the communication portion 43. A protocol for short-distance communication such as BLE, RFID, or a wireless LAN is used for the transmission of the vehicle ID 55.

Processes from step S202 to step S204 are executed by the terminal device 20 of the user 11.

In step S202, the controlling portion 21 receives the identification information of the vehicle 12 that is transmitted in step S201, from the operation support device 40 of the vehicle 12 through the communication portion 23.

More specifically, the controlling portion 21 wirelessly receives the vehicle ID 55 directly from the operation support device 40 of the vehicle 12 through the communication portion 23.

In step S203, the controlling portion 21 compares the identification information of the vehicle 12 that is received in step S202 with the identification information of the vehicle 12 that is included in the reservation response 63 received in step S107.

More specifically, the controlling portion 21 compares the vehicle ID 55 received from the operation support device 40 of the vehicle 12 with the vehicle ID 55 stored in the storage portion 22. When the vehicles ID 55 do not match each other, the controlling portion 21 waits until the controlling portion 21 subsequently receives the vehicle ID 55 in step S202. In the meantime, when the vehicles ID 55 match each other, the controlling portion 21 performs the process of step S204.

In step S204, the controlling portion 21 transmits, through the communication portion 23, the identification information of the user 11 that is included in the reservation response 63 received in step S107 in response to the identification information of the vehicle 12 that is received in step S202.

More specifically, the controlling portion 21 transmits the user ID 56 stored in the storage portion 22 in association with the vehicle ID 55 as a pair to the operation support device 40 of the vehicle 12 through the communication portion 23. A protocol for short-distance communication such as BLE, RFID, or a wireless LAN is used for the transmission of the user ID 56.

In the example of FIG. 9, the controlling portion 21 outputs the acceptance request information 64 to request an acceptance of the user 11 through the output portion 26 before the controlling portion 21 transmits the user ID 56. The acceptance request information 64 includes a message indicating that the vehicle 12 reserved by the user 11 is approaching and other pieces of information about the operation of the vehicle 12. When the controlling portion 21 receives an acceptance operation of the user 11 through the input portion 25 in response to the acceptance request information 64 thus output, the controlling portion 21 transmits the user ID 56. The acceptance operation of the user 11 may be a given operation, but in this example, the acceptance operation is to press a “YES” button on a screen.

As another example, the user ID 56 may be transmitted by auto-answer without waiting for the operation of the user 11.

Processes of step S205 and step S206 are executed by the operation support device 40 of the vehicle 12.

In step S205, the controlling portion 41 receives the identification information of the user 11 that is transmitted in step S204 from the terminal device 20 of the user 11 through the communication portion 43.

More specifically, the controlling portion 41 wirelessly receives the user ID 56 directly from the terminal device 20 of the user 11 through the communication portion 43. The controlling portion 41 stores the user ID 56 thus received in the storage portion 42.

In step S206, the controlling portion 41 transmits the identification information of the user 11 that is received in step S205 to the operation management device 30 through the communication portion 43.

More specifically, the controlling portion 41 transmits the user ID 56 stored in the storage portion 42 to the operation management device 30 through the communication portion 43.

Processes of step S207 and step S208 are executed by the operation management device 30.

In step S207, the controlling portion 31 receives the identification information of the user 11 that is transmitted in step S206, from the operation support device 40 of the vehicle 12 through the communication portion 33.

More specifically, the controlling portion 31 receives the user ID 56 from the operation support device 40 of the vehicle 12 through the communication portion 33 via the network 13. The controlling portion 31 stores the user ID 56 thus received in the storage portion 32.

In step S208, the controlling portion 31 transmits the information on the boarding position that is associated with the identification information of the user 11 in step S105 through the communication portion 33 in response to the identification information of the user 11 that is received in step S207. In the present embodiment, the controlling portion 31 further transmits the information on the getting-off position that is associated with the identification information of the user 11 in step S105. The controlling portion 31 also transmits the pieces of information on the boarding time and the getting-off time that are associated with the identification information of the user 11 in step S105.

More specifically, the controlling portion 31 searches the database 62 by use of the user ID 56 stored in the storage portion 32 as a search key. The controlling portion 31 transmits the vehicle ID 55, the boarding position information 51, the getting-off position information 52, the boarding time information 53, and the getting-off time information 54 that are obtained as a search result from the database 62, to the operation support device 40 of the vehicle 12 via the network 13 through the communication portion 33.

Processes from step S209 to step S212 are executed by the operation support device 40 of the vehicle 12.

In step S209, the controlling portion 41 receives the information on the boarding position that is transmitted in step S208, from the operation management device 30 through the communication portion 43. In the present embodiment, the controlling portion 41 further receives the information on the getting-off position that is transmitted in step S208, from the operation management device 30. The controlling portion 41 also receives the pieces of information on the boarding time and the getting-off time that are transmitted in step S208, from the operation management device 30.

More specifically, the controlling portion 41 receives the vehicle ID 55, the boarding position information 51, the getting-off position information 52, the boarding time information 53, and the getting-off time information 54 from the operation management device 30 through the communication portion 43. The controlling portion 41 stores, in the storage portion 42, the boarding position information 51, the getting-off position information 52, the boarding time information 53, and the getting-off time information 54 thus received. In a case where the vehicle ID 55 thus received is different from the vehicle ID 55 stored in the storage portion 42 in advance, the controlling portion 41 may not store, in the storage portion 42, the boarding position information 51, the getting-off position information 52, the boarding time information 53, and the getting-off time information 54 thus received.

In step S210, the controlling portion 41 acquires position information of the vehicle 12 through the positioning portion 44.

More specifically, the controlling portion 41 acquires two-dimensional coordinates or three-dimensional coordinates of a current position of the vehicle 12 as the position information of the vehicle 12 through the positioning portion 44. The controlling portion 41 stores the two-dimensional coordinates or three-dimensional coordinates thus acquired in the storage portion 42.

In step S211, the controlling portion 41 compares the position information of the vehicle 12 that is acquired in step S210 with the information on the boarding position that is received in step S209.

More specifically, the controlling portion 41 compares the two-dimensional coordinates or three-dimensional coordinates of the current position stored in the storage portion 42 with the boarding position information 51 stored in the storage portion 42.

In step S212, the controlling portion 41 executes a process corresponding to a comparison result in step S211. In the present embodiment, in a case where a difference between the position indicated by the position information acquired in step S210 and the boarding position indicated by the information received in step S209 is smaller than a first threshold, the controlling portion 41 transmits boarding guidance information 65 to guide the user 11 to board the vehicle 12 to the terminal device 20 of the user 11. Further, in a case where the difference between the position indicated by the position information acquired in step S210 and the boarding position indicated by the information received in step S209 is larger than a second threshold, the controlling portion 41 notifies the driver of the vehicle 12 that a person different from the user 11 who has made the reservation has boarded the vehicle 12. The second threshold may be the same value as the first threshold or may be a value larger than the first threshold.

More specifically, the controlling portion 41 refers to map information stored in the storage portion 42 in advance and specifies two-dimensional coordinates or three-dimensional coordinates of the boarding position indicated by the boarding position information 51 stored in the storage portion 42. The controlling portion 41 calculates a distance between the two-dimensional coordinates or three-dimensional coordinates of the current position stored in the storage portion 42 and the two-dimensional coordinates or three-dimensional coordinates of the boarding position thus specified. The controlling portion 41 compares the distance thus calculated with the first threshold. When the calculated distance is smaller than the first threshold, the controlling portion 41 transmits the boarding guidance information 65 to the terminal device 20 of the user 11 through the communication portion 43. A protocol for short-distance communication such as BLE, RFID, a wireless LAN, or the like is used for the transmission of the boarding guidance information 65. Further, the controlling portion 41 also compares the distance thus calculated with the second threshold. When the distance thus calculated is larger than the second threshold, the controlling portion 41 outputs, to the driver of the vehicle 12 through the output portion 46, a message indicating that a person different from the user 11 who has made the reservation has boarded the vehicle 12.

In the example of FIG. 10, the controlling portion 21 of the terminal device 20 wirelessly receives the boarding guidance information 65 directly from the operation support device 40 of the vehicle 12 through the communication portion 23. The controlling portion 21 outputs the boarding guidance information 65 thus received, through the output portion 26. The boarding guidance information 65 includes a message indicating that the vehicle 12 is to arrive at the boarding position requested by the user 11, an image of the vehicle 12, the name of the driver of the vehicle 12, and other pieces of information about the operation of the vehicle 12.

In the present embodiment, when the controlling portion 41 of the operation support device 40 detects that the vehicle 12 is stopping after a point of time when the identification information of the user 11 is transmitted from the terminal device 20 of the user 11 in step S204, the controlling portion 41 of the operation support device 40 determines that the user 11 has boarded the vehicle 12. After the controlling portion 41 determines that the user 11 has boarded the vehicle 12, the controlling portion 41 sequentially acquires position information of the vehicle 12. The controlling portion 41 sequentially compares the sequentially acquired position information of the vehicle 12 with the information on the getting-off position that is received in step S209. In a case where a difference between the position indicated by the sequentially acquired position information and the getting-off position indicated by the information received in step S209 becomes smaller than a third threshold, the controlling portion 41 transmits getting-off guidance information 66 to guide the user 11 to get off the vehicle 12 to the terminal device 20 of the user 11. The third threshold may be the same value as the first threshold or may be a value larger than the first threshold.

More specifically, the controlling portion 41 refers to the map information stored in the storage portion 42 in advance and specifies two-dimensional coordinates or three-dimensional coordinates of the getting-off position indicated by the getting-off position information 52 stored in the storage portion 42. After a point of time when the controlling portion 41 receives the user ID 56 from the terminal device 20 of the user 11, the controlling portion 41 determines whether the vehicle 12 is stopping or not, by use of a positioning module included in the positioning portion 44 or a sensor such as an acceleration sensor or a gyroscope provided in the vehicle 12. After the controlling portion 41 determines that the vehicle 12 is stopping, the controlling portion 41 repeatedly acquires the two-dimensional coordinates or three-dimensional coordinates of the current position of the vehicle 12 through the positioning portion 44. Every time the controlling portion 41 acquires the two-dimensional coordinates or three-dimensional coordinates of the current position, the controlling portion 41 calculates a distance between the two-dimensional coordinates or three-dimensional coordinates of the current position thus acquired and the two-dimensional coordinates or three-dimensional coordinates of the getting-off position thus specified. The controlling portion 41 compares the distance thus calculated with the third threshold. When the calculated distance is smaller than the third threshold, the controlling portion 41 transmits the getting-off guidance information 66 to the terminal device 20 of the user 11 through the communication portion 43. A protocol for short-distance communication such as BLE, RFID, or a wireless LAN is used for the transmission of the getting-off guidance information 66.

In the example of FIG. 11, the controlling portion 21 of the terminal device 20 wireles sly receives the getting-off guidance information 66 directly from the operation support device 40 of the vehicle 12 through the communication portion 23. The controlling portion 21 outputs the getting-off guidance information 66 thus received, through the output portion 26. The getting-off guidance information 66 includes a message indicating that the vehicle 12 is to reach the getting-off position requested by the user 11 and other pieces of information about the operation of the vehicle 12.

As another example, the getting-off guidance information 66 may be transmitted and output when the getting-off time is coming, not when the vehicle 12 is coming closer to the getting-off position.

As one modification of the present embodiment, the vehicle ID 55 may be transmitted inside the vehicle 12 instead of being transmitted to outside the vehicle 12. In this case, in step S201, the controlling portion 41 of the operation support device 40 transmits the vehicle ID 55 inside the vehicle 12 through the communication portion 43. In a case where the identification information of the user 11 is transmitted from the terminal device 20 of the user 11 in step S204, the controlling portion 41 determines that the user 11 has boarded the vehicle 12, regardless of whether it is detected that the vehicle 12 is stopping or not.

As one modification of the present embodiment, the fare from the boarding position requested by the user 11 is settled at the time of making a reservation, and when a difference between an actual boarding position and the boarding position requested by the user 11 is large at the time of boarding the vehicle 12, a difference in fare corresponding to the difference between the actual boarding position and the boarding position requested by the user 11 may be settled. In this case, in the operation in FIG. 3, the fare corresponding to a boarding section found from the boarding position information 51 and the getting-off position information 52 is settled in advance in a given settlement method such as electronic money, a debit card, or a credit card. In step S212, in a case where a difference between the position indicated by the position information acquired in step S210 and the boarding position indicated by the information received in step S209 is larger than a fourth threshold, the controlling portion 41 of the operation support device 40 settles a difference in fare corresponding to the above difference in a given settlement method such as electronic money, a debit card, or a credit card. The fourth threshold may be the same value as the first threshold or may be a value larger than the first threshold.

As described above, in the present embodiment, the operation support device 40 supports the operation of the vehicle 12 for which the operation plan is determined in accordance with the boarding position requested by the reservation made by the user 11. When the identification information of the user 11 is transmitted from the terminal device 20 of the user 11 in response to the identification information of the vehicle 12 that is wireles sly transmitted from the vehicle 12 during operation, the controlling portion 41 of the operation support device 40 acquires position information of the vehicle 12. The controlling portion 41 compares the position information thus acquired with the information on the boarding position associated with the identification information of the user 11 at the time of making the reservation. Accordingly, with the present embodiment, when a person boards the vehicle 12, the position of the vehicle 12 is compared with a boarding position requested by the person, so that it is possible to check whether the person is the user 11 who has made the reservation or not.

In the present embodiment, the controlling portion 31 of the operation management device 30 receives, through the communication portion 33, the identification information of the user 11 that is transmitted from the vehicle 12 for which the operation plan is determined in accordance with the boarding position requested by the reservation made by the user 11, the identification information of the user 11 being transmitted from the vehicle 12 during operation. The controlling portion 31 transmits, through the communication portion 33, information on the boarding position associated with the identification information of the user 11 at the time of making the reservation, in response to the identification information of the user 11. Accordingly, with the present embodiment, when a person has boarded the vehicle 12, the vehicle 12 can acquire the information on the boarding position requested by the person.

In the present embodiment, the controlling portion 21 of the terminal device 20 receives, through the communication portion 23, the identification information of the vehicle 12 that is wireles sly transmitted from the vehicle 12 for which the operation plan is determined in accordance with the boarding position requested by the reservation made by the user 11, the identification information being transmitted from the vehicle 12 during operation. The controlling portion 21 transmits the identification information of the user 11 through the communication portion 23 in response to the identification information of the vehicle 12. Accordingly, with the present embodiment, when a person boards the vehicle 12, the vehicle 12 can identify the person.

As one modification of the present embodiment, the database 62 may be constructed in the storage portion 42 of the operation support device 40. In this case, in step S105, the user ID 56, the vehicle ID 55, the boarding position information 51, the getting-off position information 52, the boarding time information 53, and the getting-off time information 54 are registered in the database 62 of the operation support device 40 of the vehicle 12 arranged in step S104. The processes from step S206 to step S209 are omitted. The controlling portion 41 of the operation support device 40 acquires information necessary for the process of step S211 by searching the database 62 by use of the user ID 56 as a search key like the process of step S208.

As one modification of the present embodiment, the operation support device 40 may be constituted as a server belonging to a cloud computing system or other computing systems. The operation support device 40 may be integrated with the operation management device 30. In this case, the processes of step S201, step S205, step S206, and step S212 are executed by the vehicle 12. The processes of step S208 and step S209 are omitted. The processes of step S210 and step S211 are executed by the server. In step S210, the position information of the vehicle 12 is acquired by being uploaded to the server from the vehicle 12. In step S212, a comparison result is transmitted to the vehicle 12 from the server.

The present disclosure is not limited to the above embodiment. For example, a plurality of blocks described in the block diagram may be integrated, or one block may be divided. Instead of sequentially executing a plurality of steps described in the flowchart in accordance with the description, they may be executed in parallel or in a different order in accordance with processing capacities of the devices that execute respective steps or as necessary. Furthermore, the present disclosure may be variously modified without departing from the gist of the present disclosure.

What is claimed is:

1. An operation support device for supporting an operation of a vehicle for which an operation plan is determined in accordance with a boarding position requested by a reservation made by a user, the operation support device comprising a controlling portion configured to acquire position information of the vehicle when identification information of the user is transmitted from a terminal device of the user in response to identification information of the vehicle that is wireles sly transmitted from the vehicle during operation, the controlling portion being configured to compare the acquired position information with information on the boarding position associated with the identification information of the user at a time of making the reservation.

2. The operation support device according to claim 1, wherein:
the identification information of the vehicle is transmitted to outside the vehicle; and
in a case where a difference between a position indicated by the acquired position information and the boarding position is smaller than a threshold, the controlling portion transmits boarding guidance information to guide the user to board the vehicle to the terminal device of the user.

3. The operation support device according to claim 1, wherein:
the operation plan is determined in accordance with the boarding position and a getting-off position requested by the reservation;
after the controlling portion determines that the user has boarded the vehicle, the controlling portion sequentially acquires position information of the vehicle and sequentially compares the sequentially acquired position information with information on the getting-off position associated with the identification information of the user at the time of making the reservation; and
when a difference between a position indicated by the sequentially acquired position information and the getting-off position becomes smaller than a threshold, the controlling portion transmits getting-off guidance information to guide the user to get off the vehicle to the terminal device of the user.

4. The operation support device according to claim 1, wherein, when the controlling portion detects that the vehicle is stopping after a point of time when the identification information of the user is transmitted from the terminal device of the user, the controlling portion determines that the user has boarded the vehicle.

5. The operation support device according to claim 1, wherein:
the identification information of the vehicle is transmitted inside the vehicle; and
when the identification information of the user is transmitted from the terminal device of the user, the controlling portion determines that the user has boarded the vehicle.

6. The operation support device according to claim 1, wherein, when a difference between a position indicated by the acquired position information and the boarding position is larger than a threshold, the controlling portion notifies a driver of the vehicle that a person different from the user has boarded the vehicle.

7. The operation support device according to claim 1, wherein:
a fare from the boarding position is settled at the time of making the reservation; and
when a difference between a position indicated by the acquired position information and the boarding position is larger than a threshold, the controlling portion settles a difference in fare corresponding to the difference between the position indicated by the acquired position information and the boarding position.

8. The operation support device according to claim 1, wherein:
the operation support device is provided in the vehicle;
the operation support device further includes a communication portion configured to wirelessly transmit and receive information; and
the controlling portion repeatedly transmits the identification information of the vehicle through the communication portion.

9. A vehicle comprising the operation support device according to claim 1.

10. An operation management device comprising:
a communication portion configured to transmit and receive information; and
a controlling portion configured to receive, through the communication portion, identification information of a user that is transmitted from a vehicle for which an operation plan is determined in accordance with a boarding position requested by a reservation made by the user, the identification information of the user being transmitted from the vehicle during operation, the controlling portion being configured to transmit, through the communication portion, information on the boarding position associated with the identification information of the user at a time of making the reservation, in response to the identification information of the user.

11. A terminal device comprising:
a communication portion configured to wireles sly transmit and receive information; and
a controlling portion configured to receive, through the communication portion, identification information of a vehicle for which an operation plan is determined in accordance with a boarding position requested by a reservation made by a user, the identification information of the vehicle being wirelessly transmitted from the vehicle during operation, the controlling portion being configured to transmit, through the communication portion, identification information of the user in response to the identification information of the vehicle.

12. The terminal device according to claim 11, further comprising:
an output portion configured to output information; and
an input portion configured to receive an operation of the user, wherein:
before the controlling portion transmits the identification information of the user, the controlling portion outputs acceptance request information to request an acceptance of the user through the output portion; and
when the controlling portion receives an acceptance operation by the user through the input portion in response to the acceptance request information thus output, the controlling portion transmits the identification information of the user.

13. An operation support method comprising:
wirelessly transmitting identification information of a vehicle for which an operation plan is determined in accordance with a boarding position requested by a reservation made by a user, the identification information of the vehicle being transmitted by the vehicle during operation;
receiving, by a terminal device of the user, the identification information of the vehicle;
transmitting, by the terminal device of the user, identification information of the user in response to the identification information of the vehicle;
acquiring, by an operation support device, position information of the vehicle; and
comparing, by the operation support device, the acquired position information with information on the boarding position associated with the identification information of the user at a time of making the reservation.
